(19) United States
(12) Patent Application Publication
(10) Pub. No.: US 2017/0275070 A1
(43) Pub. Date: Sep. 28, 2017

(54) EDIBLE AND BIODEGRADABLE PACKAGE MATERIALS

(71) Applicant: 1 Mighty Mogul, Inc., Los Angeles, CA (US)

(72) Inventors: SHERRY SOLOMON, LOS ANGELES, CA (US); DANA SOLOMON, LOS ANGELES, CA (US)

(21) Appl. No.: 15/512,339

(22) PCT Filed: Sep. 18, 2015
(86) PCT No.: PCT/US15/51022

§ 371 Date: Mar. 17, 2017

Related U.S. Application Data
(60) Provisional application No. 62/052,274, filed on Sep. 18, 2014.

(51) Int. Cl. B65D 65/46; B65B 7/02; B65D 81/05; B29C 47/00; C08L 5/00; C08L 1/02; B41J 3/407; B65B 3/04; C08L 89/00

(52) U.S. Cl. CPC B65D 65/463; B65B 3/04; B65B 7/02; B65D 81/052; C08L 89/00; C08L 5/00; C08L 1/02; B41J 3/4075; B29C 47/0021; C08L 2205/02; C08L 2205/03; C08L 2203/16; B29L 2007/00

(57) ABSTRACT

The invention relates to an edible and biodegradable package material composition and uses thereof. Specifically, the invention relates to a package material composition comprising a polysaccharide component, a protein component, or a combination thereof, in order to produce a transformational package that is both edible and naturally biodegradable. The package material composition of the invention provides a structural integrity to serve a full range of uses for packaging and shipping of both wet and dry products.

### CROSS-REFERENCE TO RELATED APPLICATIONS

This application claims priority to U.S. Provisional Patent Application 62/052,274, filed Sep. 18, 2014, which is incorporated by reference herein in its entirety.

### FIELD OF THE INVENTION

The invention relates to an edible and biodegradable package material composition and uses thereof. Specifically, the invention relates to a package material composition comprising a polysaccharide component, a protein component, or a combination thereof, in order to produce a transformational package that is both edible and naturally biodegradable.

### BACKGROUND OF THE INVENTION

Many different materials are used for packaging including metals, glass, wood, paper or pulp, plastics or combinations thereof. Most of these enter municipal waste streams at the end of their service life.

The materials mostly used for food packaging are the petrochemical-based polymers or plastics because of their availability in large quantities at low cost and desirable characteristics, such as tensile and tear strength, barrier properties to oxygen and heat sealability. However, these materials can present a significant disposal problem because they do not readily degrade, especially in landfills.

Specifically, the durability of plastic has a huge negative environmental impact. Plastic is not biodegradable, but photodegradable. In reality, most plastic does not ever disappear, but becomes long lasting “plastic dust”. When items like plastic bags or bottles break down, they readily soak up and release toxins, which then contaminate soil and water, and harm animals that ingest plastic fragments.

Burning plastic releases dangerous chemicals including dioxins and furans. Studies have linked dioxins and furans to cancer and respiratory disease.

In view of the environmental concerns, the inability to degrade can be a significant problem.

Recently, the consumer demand has been growing for environmentally friendly biodegradable materials, for example, from renewable farm by-products, food processing wastes, and low cost natural resources.

To date, efforts in creating viable and economical fully biodegradable materials have focused primarily on blending known biodegradable polymeric resins such as polyesters with starch to reduce the cost. However, these blended materials have substantial physical drawbacks such as lack of structural strength for shipping and handling, low elongation resistance, low puncture resistance, poor moisture resistance, and mechanical and rheological properties.

Current art for the mechanical properties of unmodified starch is typically quite fragile and brittle when dry. Fiber is often added to the formulation to increase the flexural strength and fracture energy of starch-based products. Attempts have been made to add significant amounts of fiber, however when stored for extended periods, the product remains brittle and continues to present problems. Furthermore, although fiber from wood pulp is a renewable material, the time required to grow a tree is substantial and the chemicals used in processing wood are toxic.

Additionally, consumers started showing interest towards edible packaging that can be as safe and commercially viable.

Accordingly, there exists a need for improved biodegradable and edible packaging materials.

### SUMMARY OF THE INVENTION

In one aspect, the invention provides an edible and biodegradable package material composition, said composition comprising: a polysaccharide component, a protein component, or a combination thereof, wherein said polysaccharide component is a carrageenan and said protein component is a zein, a gluten, a soy protein, a whey protein, or a combination thereof. In one exemplary embodiment, said composition further comprises a plasticizer, for example, a glycerin or glycerol. In another exemplary embodiment, said composition further comprises a gelling agent, for example, a gelatin.

In another aspect, the invention provides an edible and biodegradable package material composition, said composition comprising a plurality of first layers and one or more second layers, wherein the second layer is present between two first layers, wherein the second layer has a plurality of openings that facilitate said two first layers to bond with each other, wherein the first layer comprises an ingredient for providing a mechanical strength, for example, a protein component and the second layer comprises an ingredient for providing a moisture resistance, for example, a polysaccharide (e.g., carrageenan).

In yet another aspect the invention provides a package molded by an edible and biodegradable package material composition of the invention.

In an addition aspect, the invention provides a method for making a package, said method comprising: providing an edible and biodegradable package material composition, heating said composition, molding said composition into said package.

In a further aspect, the invention provides a method for making a package, said method comprising: providing a first composition and second composition, wherein said first composition comprises a protein component and said second composition comprises a polysaccharide (e.g., carrageenan); heating said first and second compositions; molding said first composition in to a first layer and said composition in to a second layer; and placing said second layer between two first layers.

Other features and advantages of the present invention will become apparent from the following detailed description examples and figures. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

FIG. 1: 1A and 1B show wheat gluten film, according to one embodiment of the invention.

FIG. 2: 2A and 2B show a film having wheat gluten and carrageenan, according to one embodiment of the invention.

FIG. 3: 3A and 3B show a film having wheat gluten and corn zein, according to one embodiment of the invention.

FIG. 4 shows a film having soy protein isolate, carrageenan, coffee (Arabica), and sugar, according to one embodiment of the invention.

FIG. 5: 5A and 5B show a film having carrageenan, according to one embodiment of the invention.

FIG. 6 shows a film having gelatin, according to one embodiment of the invention.

FIG. 7 shows a film having corn zein and gelatin, according to one embodiment of the invention.

FIG. 8: 8A and 8B show a film having cellulose and carrageenan, according to one embodiment of the invention.

FIG. 9: 9A and 9B show a film having corn zein and carrageenan, according to one embodiment of the invention.

FIG. 10 shows a process of applying purified protein onto the edible membranes (A-D) to glue them together and the glued membranes sticking to each other after 3 weeks (E-H), according to one embodiment of the invention.

FIG. 11 shows a straw having corn zein, whey, and xanthum gum (with vitamins and minerals), according to one embodiment of the invention.

FIG. 12 shows label printing with edible ink and paper, according to one embodiment of the invention.

FIG. 13 shows layering for liquid barrier: 5 layer design, holes allow for thermal welding, according to one embodiment of the invention.

FIG. 14 shows liquid packaging construction: Tube structure was formed by thermal press of multi-layers with label and impulse sealing.

FIG. 15 shows liquid packaging for carton-style, according to one embodiment of the invention.

FIG. 16 shows filling container, according to one embodiment of the invention.

FIG. 17 shows package sealed with liquid, according to one embodiment of the invention.

FIG. 18 shows liquid packaging, with shots of internal layers after ˜4 hours exposure, according to one embodiment of the invention.

FIG. 19 shows liquid packaging for tetra-pak style, according to one embodiment of the invention.

FIG. 20 shows gelatin air bags which are padding for shipping containers, according to one embodiment of the invention.

FIG. 21 shows that material can be thermoformed or vaccuformed beginning with sheet form, according to one embodiment of the invention.

FIG. 22 shows gelatin pack: welding of label and thermal forming shape, according to one embodiment of the invention.

FIG. 23 shows gelatin packaging with edible wafer paper label, according to one embodiment of the invention.

FIG. 24 shows gelatin front with wafer paper or corn rear, according to one embodiment of the invention.

FIG. 25 shows a package material made of corn with wafer rear, gelatin and wafer front, according to one embodiment of the invention.

FIG. 26 shows a package having gelatin viewing window with wafer paper and corn front, according to one embodiment of the invention.

FIG. 27. 27A shows 3-layer thermal bonding. Corn zein bonds to its self with carrageenan as intermediate layer. Increases strength; 27B shows 5-layer thermal bonding. Corn zein bonds to its self with carrageenan as intermediate layer. Carrageenan layers are offset to further increase strength.

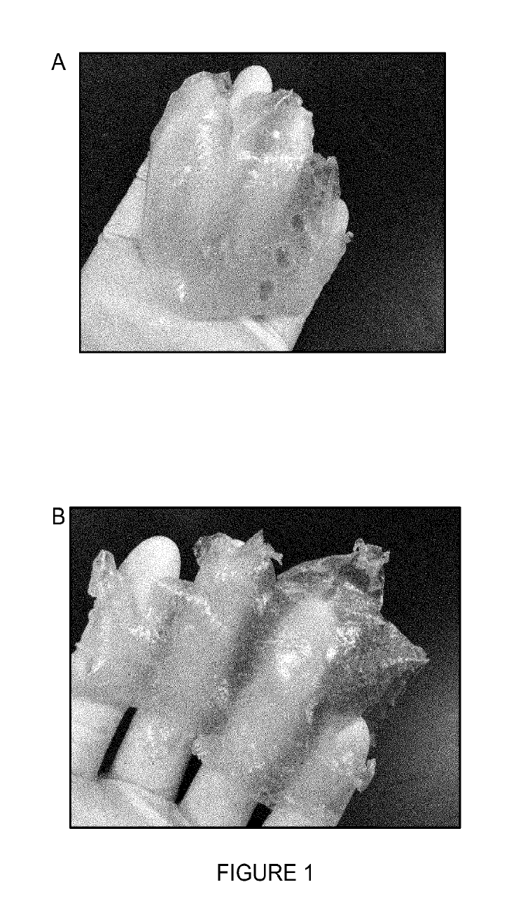

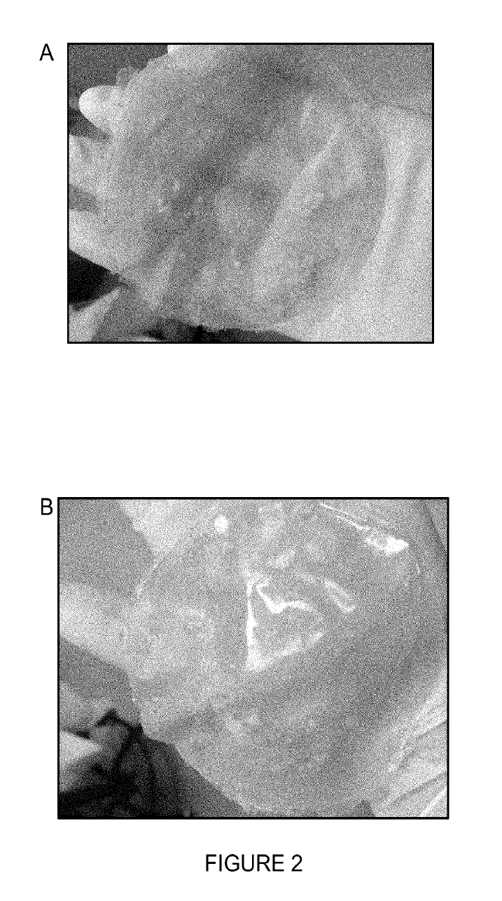

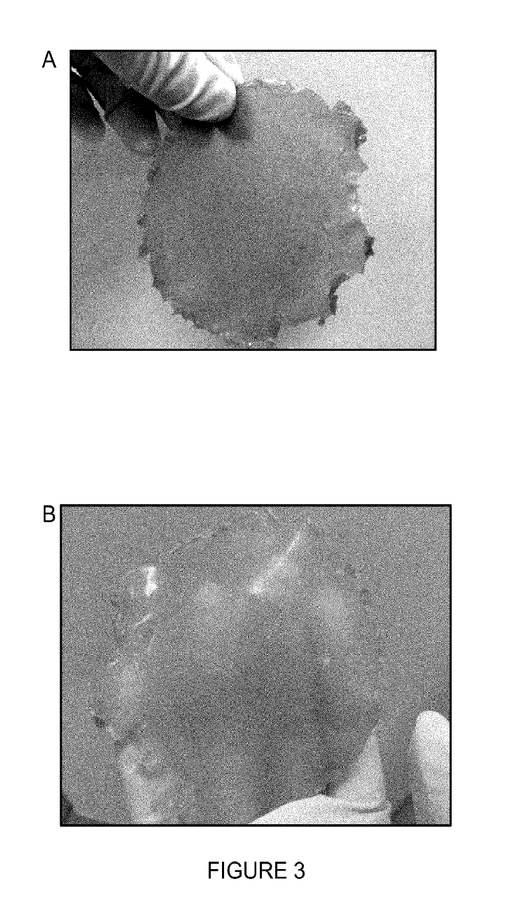

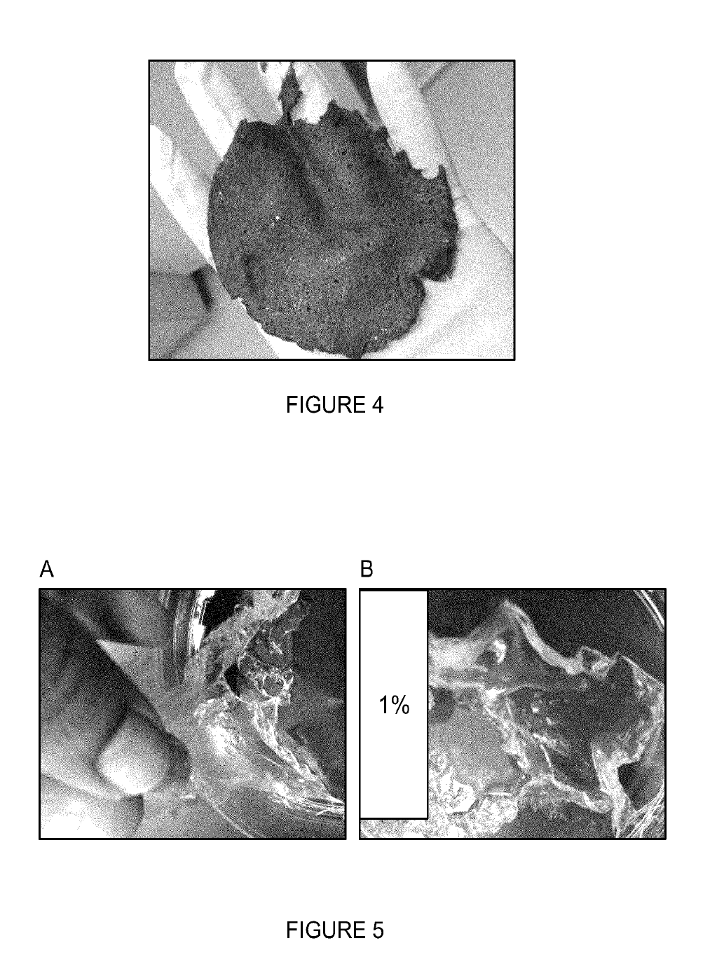

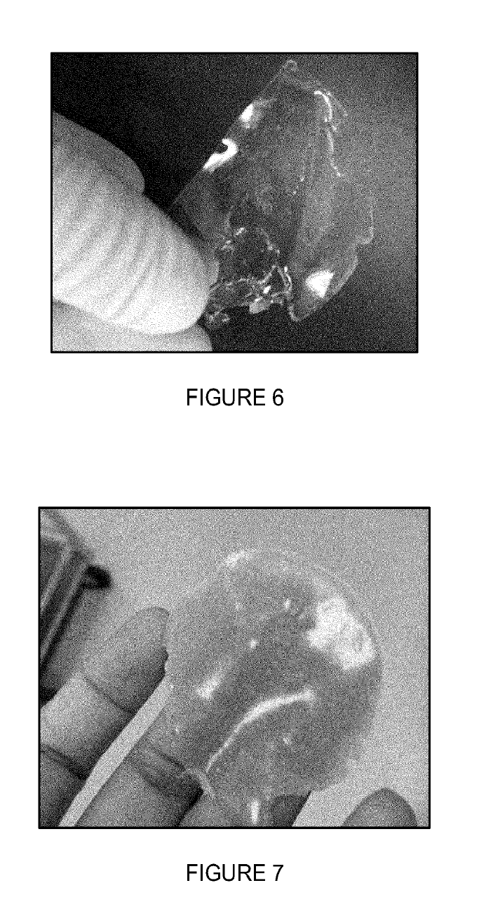

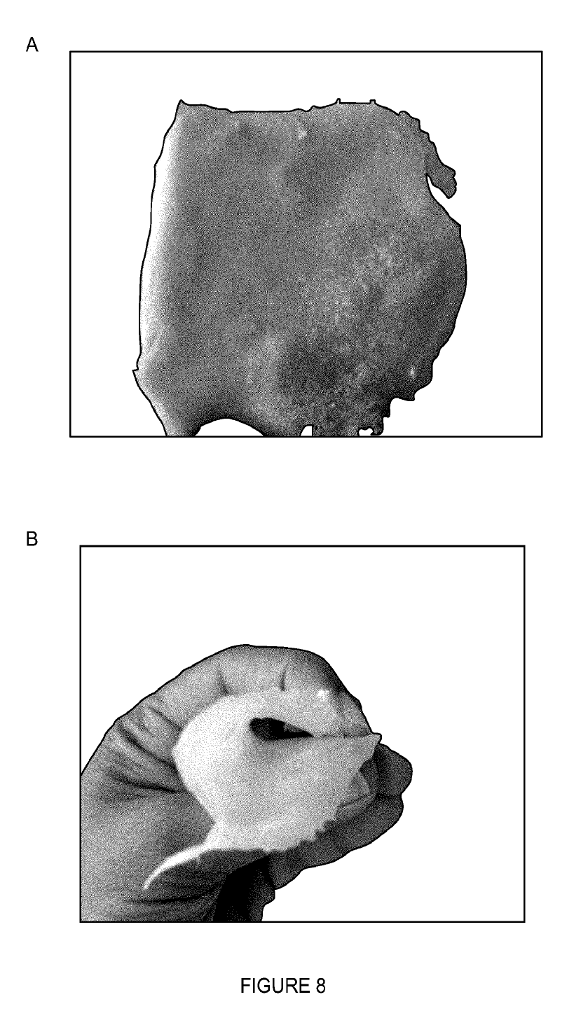

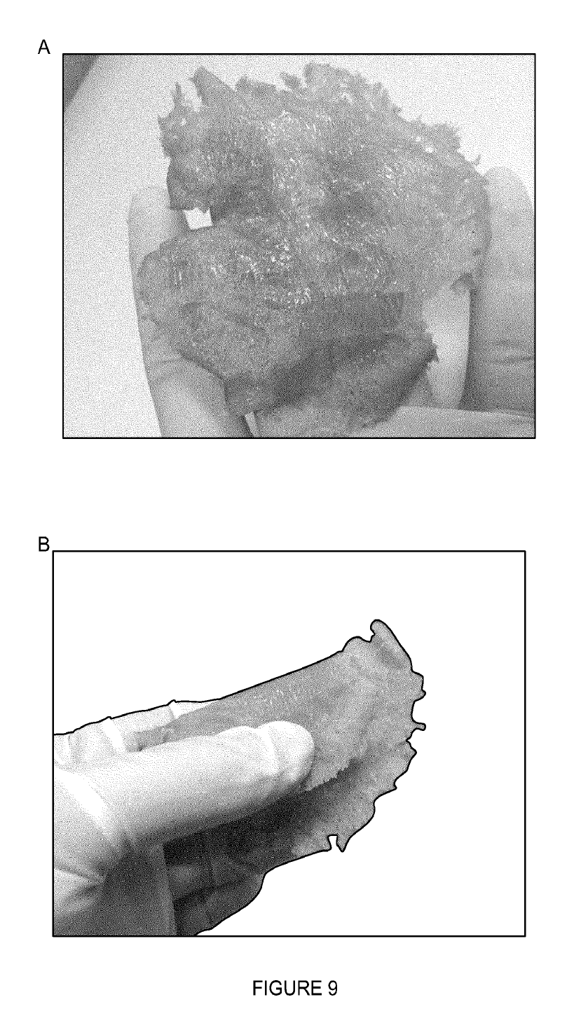

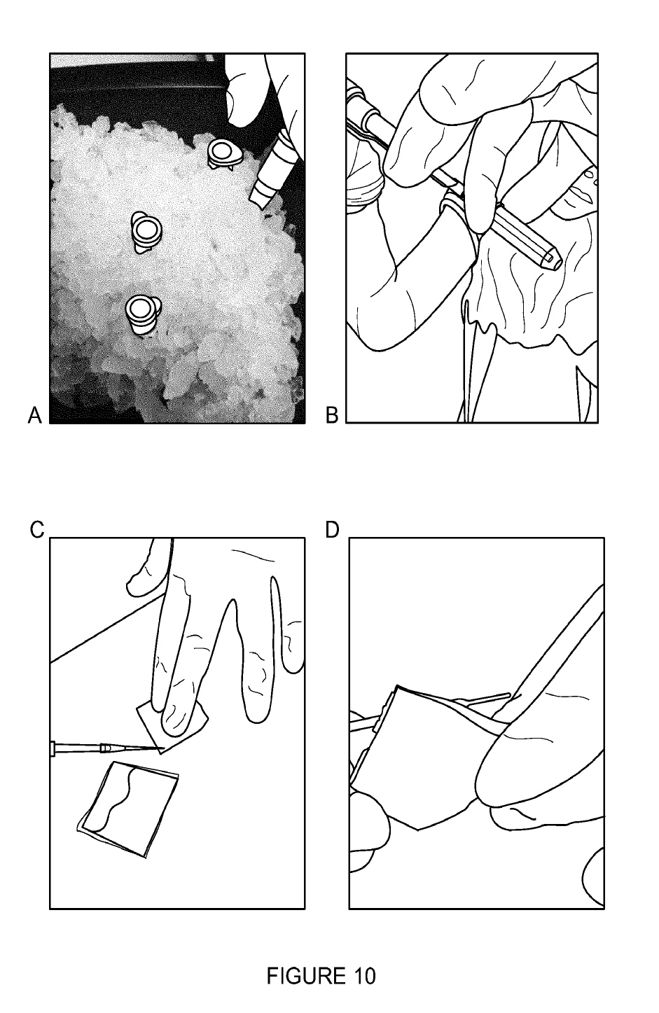

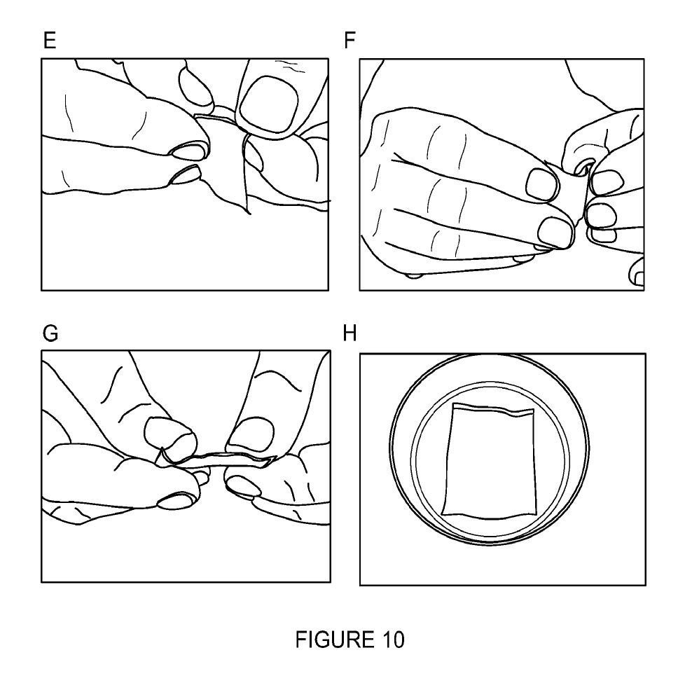

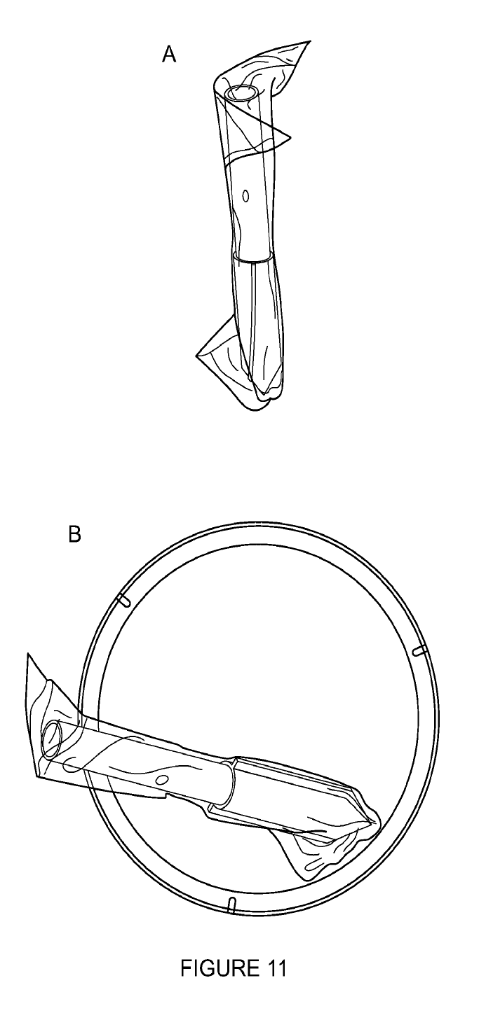

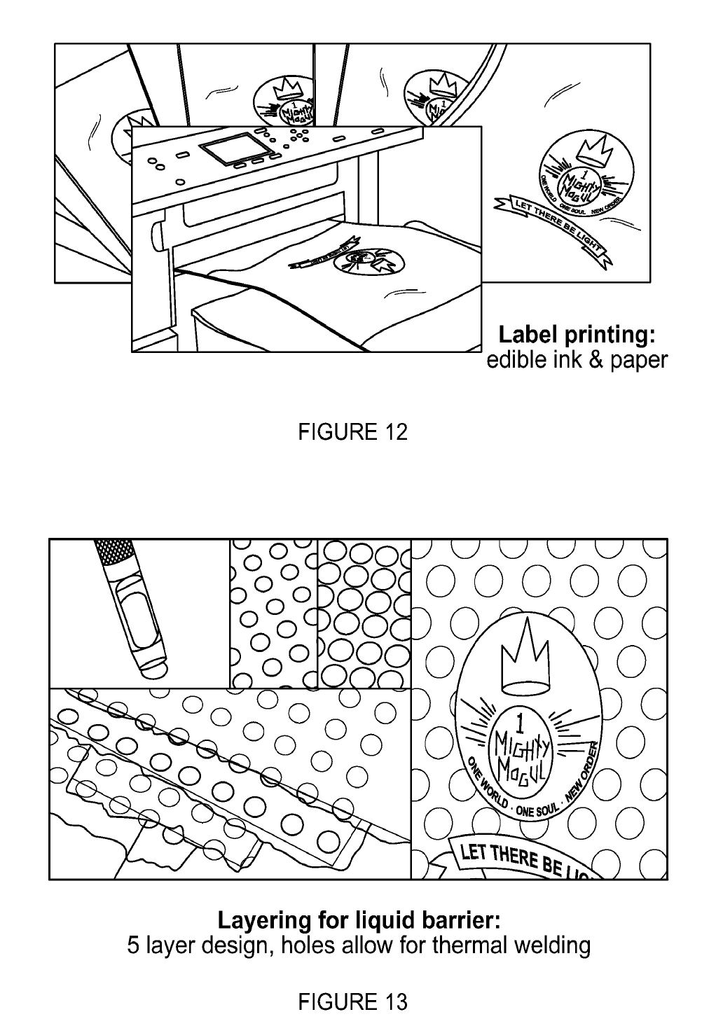

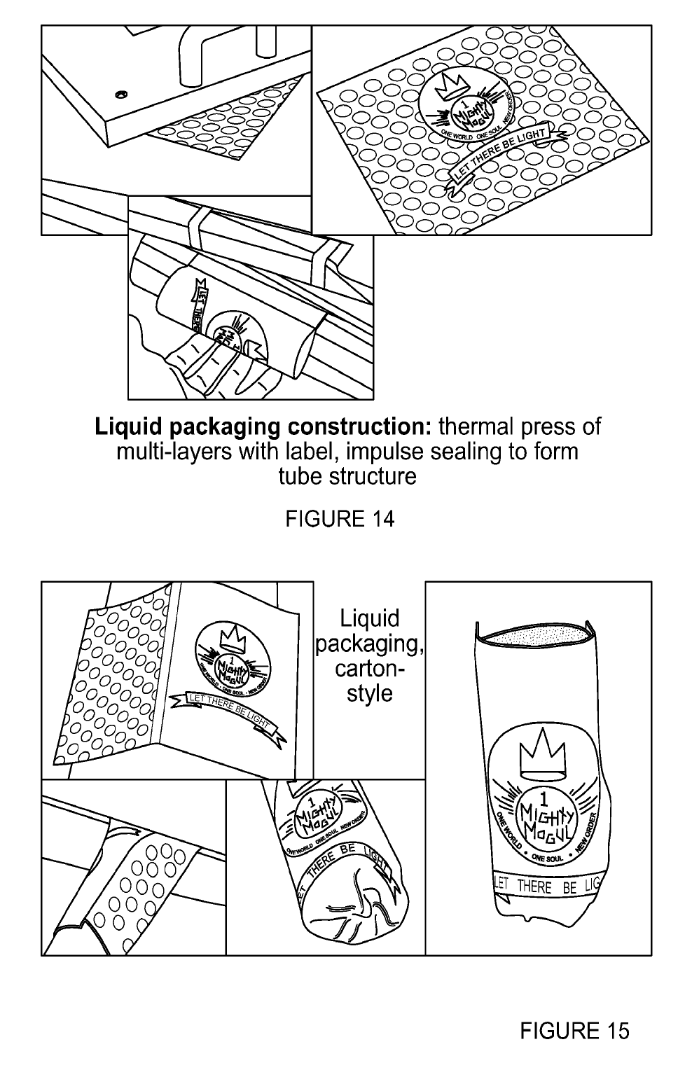

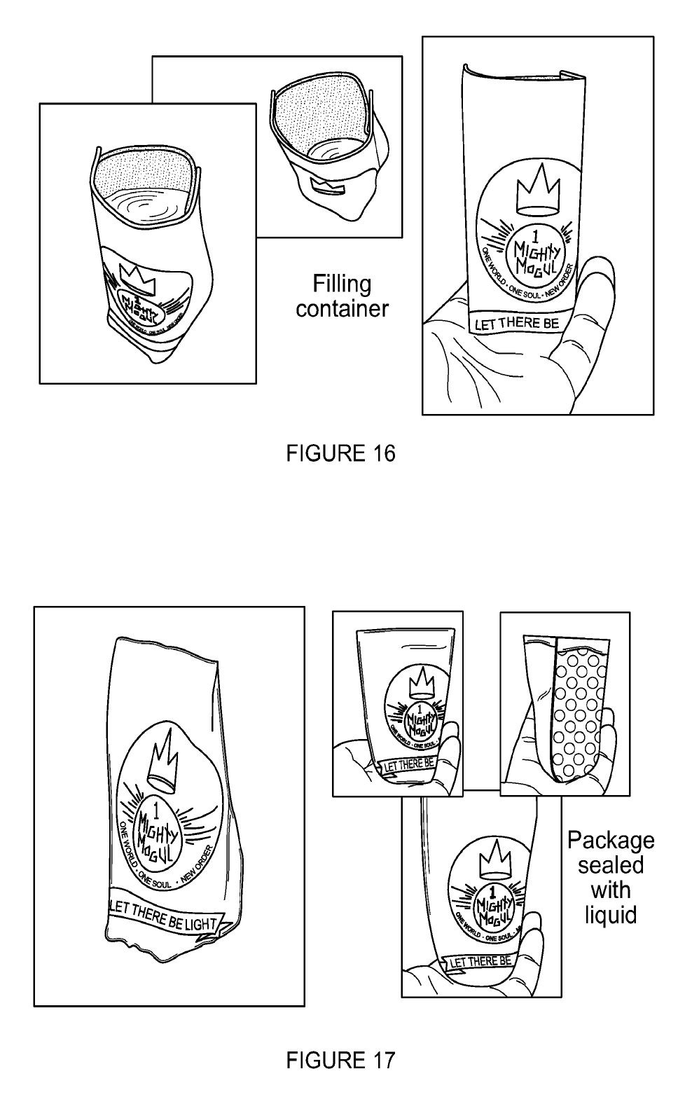

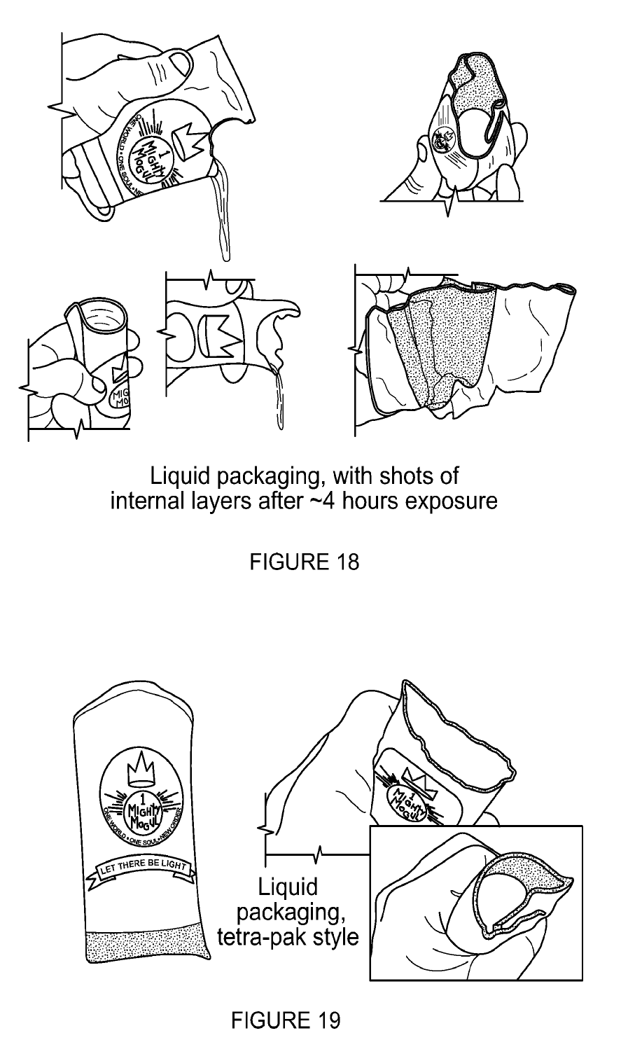

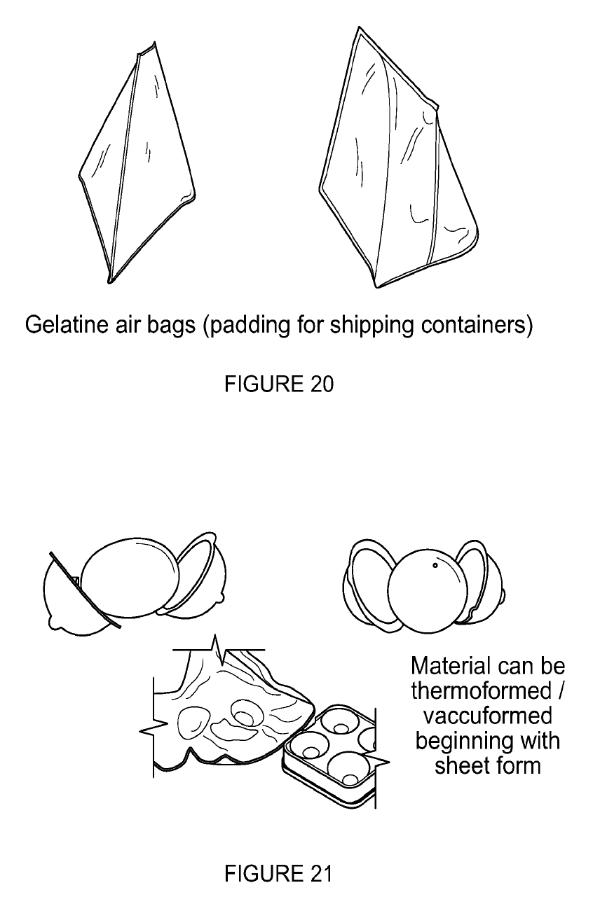

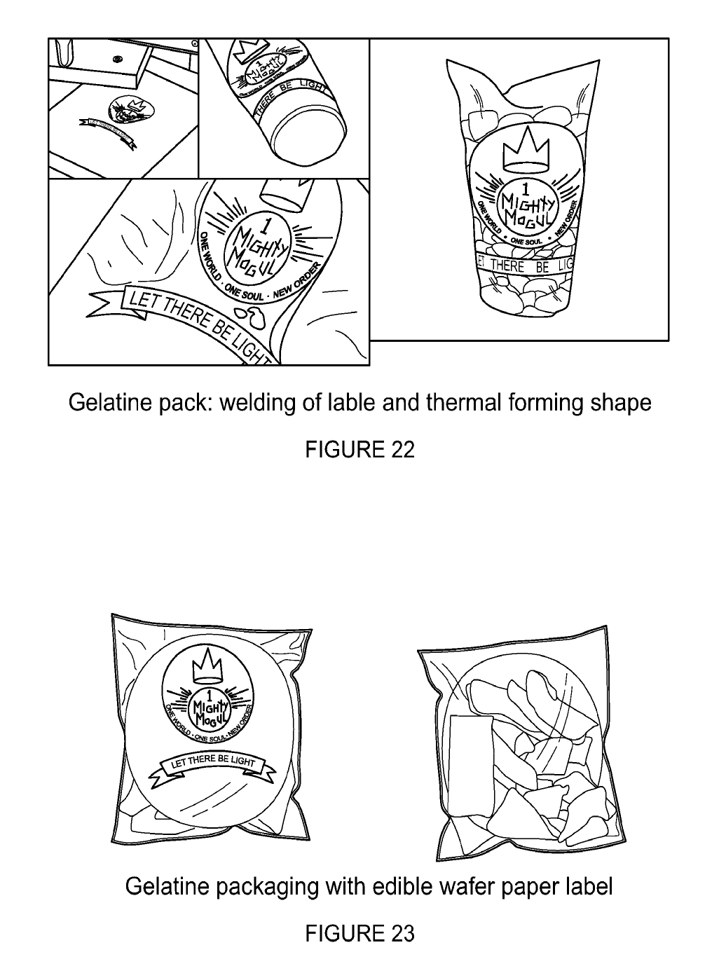

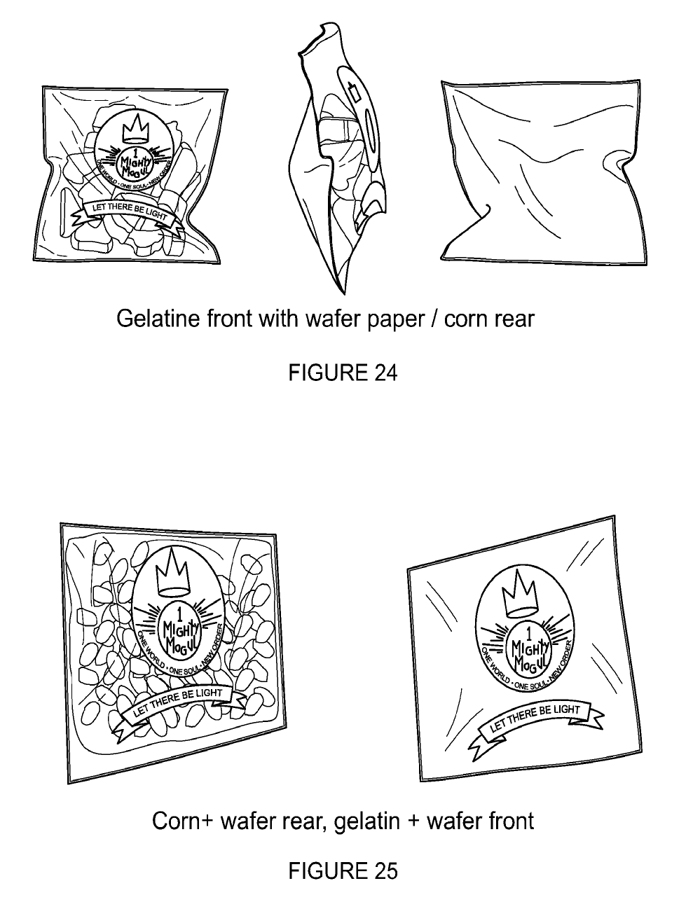

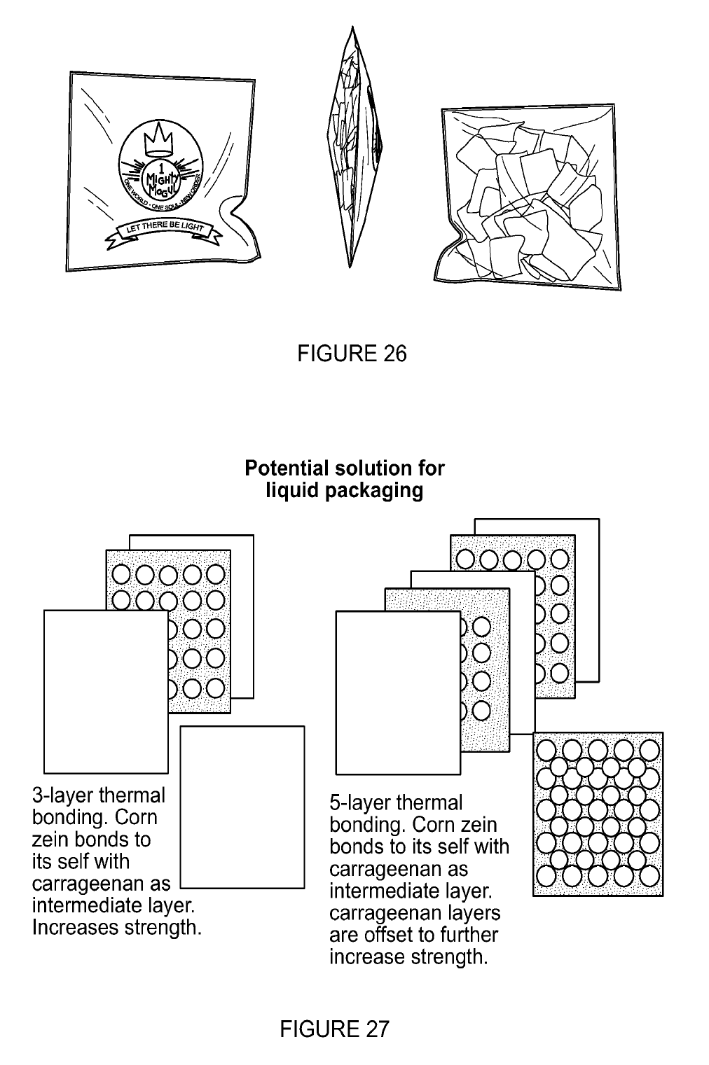

### DETAILED DESCRIPTION OF THE INVENTION

The invention relates to an edible and biodegradable package material composition and uses thereof. Specifically, the invention relates to a package material composition comprising a polysaccharide component, a protein component, or a combination thereof, in order to produce a transformational package that is both edible and naturally biodegradable.

Surprisingly and unexpectedly, the inventors of the instant application have developed a package material composition comprising a polysaccharide component (e.g., carrageenan), a protein component, or a combination thereof, in order to provide a structural integrity to serve a full range of uses for packaging and shipping of both wet and dry products.

Any suitable polysaccharide known to one of skilled in the art can be used. In a particular embodiment, the polysaccharide component is a carrageenan.

Carrageenan is a high-molecular-weight polysaccharide made up of repeating galactose units and 3,6 anhydrogalactose (3,6-AG), extracted from an edible seaweed, for example, but not limited to, Chondrus crispus, Kappaphycus alvarezii, and Eucheuma denticulatum. In carrageenan, the galactose units are joined by alternating α-1,3 and β-1,4 glycosidic linkages.

In one example, the carrageenan of the invention is a sulfated carrageenan. In another example, the carrageenan of the invention is a non-sulfated carrageenan. Examples of sulfated carrageenan include, for example, but not limited to, kappa-carrageenan, Iota-carrageenan, and lambda carrageenan. The primary differences that influence the properties of kappa, iota, and lambda carrageenan are the number and position of the ester sulfate groups on the repeating galactose units. Kappa-carrageenan has one sulphate group per disaccharide, lota-carrageenan has two sulphates per disaccharide, and lambda carrageenan has three sulphates per disaccharide. Higher levels of ester sulfate lower the solubility temperature of the carrageenan and produce lower strength gels, or contribute to gel inhibition.

In one preferred embodiment, the carrageenan of the invention is a kappa-carrageenan, which forms strong, rigid gels in the presence of potassium ions. In another preferred embodiment, the carrageenan of the invention is a lota-carrageenan, which forms soft gels in the presence of calcium ions.

Any suitable concentration of the carrageenan, known to one of skilled in the art, can be used for the composition of the invention. In one example, the concentration of the carrageenan in the package material composition ranges from about 5% to about 100% (w/w), preferably from about 20% to about 70% (w/w), and more preferably from about 30% to about 60% (w/w). In another example, the concentration of the carrageenan in the package material composition is 5, 10, 20, 30, 40, 50, 60, 70, 80, 90, 95, 98, 99, or 100% (w/w).

Other suitable polysaccharides, known to one of skilled in the art can also be used in the invention. In one example, the polysaccharide is a starch based polysaccharide. In another example, the polysaccharide is a non-starch based polysaccharide.

Starch based polysaccharides can be obtained from, for example, corn, rice, potato, and other starch rich plants. In a particular example, the starch based polysaccharide is a thermoplastic starch.

The non-starch based polysaccharide may be a seaweed extract, a cellulose or its derivative, a chitosan, a pectin, a gellan gum, a xanthan gum, an exudate gum, or a seed gum.

Examples of the seaweed extract include, but not limited to, agar, alginate, carrageenan, and furcellaran. Examples of a cellulose derivative include, but not limited to, carboxymethyl cellulose, methyl cellulose, hydroxypropyl cellulose, and microcrystalline cellulose. Examples of an exudate gum include, but not limited to, gum arabic, gum ghatti, gum karaya, and gum tragacanth. Examples of a seed gum include, but not limited to, guar gum and locust bean gum.

In another aspect, the package material composition includes a protein component. The protein may be a film forming protein, a thermoplastic protein, or a combination thereof. The protein may be obtained from a natural source, known to one of skilled in the art. Plant proteins such as, for example, but not limited to zein (e.g., corn zein), gluten (e.g., wheat gluten), and soy protein, and animal proteins such as, for example, but not limited to, milk proteins (e.g., whey protein), collagen, gelatin, keratin, and myofibrillar proteins may be used. Other proteins such as, for example, albumin, casein, a peanut protein, or a cotton seed protein can also be used.

In a preferred embodiment, the protein component is zein or gluten. Zein is a class of prolamine protein found in corn. In Zea mays, the 22 kDa and 19 kDa zeins are encoded by a large multigene family and are the major seed storage proteins accounting for 70% of the total zein fraction.

Gluten is a protein composite found in wheat and related grains, including barley and rye. Gluten is the composite of the storage proteins, gliadin and a glutenin, and is conjoined with starch in the endosperm of grains.

Any suitable concentration of the protein, known to one of skilled in the art, can be used for the composition of the invention. In one example, the concentration of the protein in the package material composition ranges from about 5% to about 100% (w/w), preferably from about 20% to about 70% (w/w), and more preferably from about 30% to about 60% (w/w). In another example, the concentration of the protein in the package material composition is 5, 10, 20, 30, 40, 50, 60, 70, 80, 90, 95, 98, 99, or 100% (w/w).

In another aspect, the package material composition includes one or more fiber components. Examples of a fiber component include, but not limited to, recycled paper pulp, wood fiber, plant fiber (e.g., banana, cotton, hemp, jute, flax, ramie, sisal, and bagasse,), animal fiber, and cellulose fiber.

The package material composition may also include a thickening agent. In one embodiment, the thickening agent is a gelling agent, for example, but not limited to, include a natural gum, a starch, a pectin, an agar-agar, and a gelatin. In a particular embodiment, the thickening agent is a gelatin.

The package material composition may further include a plasticizing agent. In one embodiment, the plasticizing agent is a bio based plasticizing agent, for example, but not limited to glycerol, an acetylated monoglyceride, and an alkyl citrate.

In another aspect, the package material composition includes a solvent. In one example, the solvent is an organic solvent.

Any suitable sugar, known to one of skilled in the art can be added to the composition of the invention. Examples of sugar include, for example, but not limited to, sucrose, glucose, fructose, galactose, maltose, and lactose. In a particular embodiment, sugar obtained from a natural source, for example, sugarcane and sugar beet, can be used.

In one example, the package material composition includes a sweetner or a natural sugar substitute. Examples of a natural sugar substitute include, for example, but not limited to, glycerol, mannitol, sorbitol, and tagatose.

In another aspect, the package material composition includes a flavoring agent. Any desired and suitable flavor can be used. Examples of a flavor include, for example, but not limited to, coffee, green tea, strawberry, mango, passion fruit, peach, pomegranate, avocado, spice, honey, melon, basil, and chocolate flavor.

In addition, the package material composition may include a coloring agent. Any desired and suitable color can be used. In one example, the coloring agent is a natural coloring agent that can provide, for example, red, yellow, green, white, neon, purple, or pink color.

The package material composition may also include a vitamin, a mineral, or any suitable nutraceutical ingredient known to one of skilled in the art.

In another aspect, the package material composition includes a lipid component, for example, but not limited to, oil (e.g., oil obtained from a natural source), an animal fat, or a vegetable fat.

In yet another aspect, the package material composition includes an antimicrobial agent. Examples of an antimicrobial agent include, for example, but not limited to, enzyme (e.g., lysozyme, peroxidase), chitosan, bacteriocin (e.g., nicin, pediocin), antibiotic, organic acid (e.g., benzoic, sorbic, ascorbic, and propionic acid), spices (e.g., rosemary, garlic, thymol), citrus extract, isothiocyanate, fungicide (e.g., benomyl, ethanol), and oxidizer (e.g., ozone, chlorine dioxide).

The package material composition may further include an adhesive protein. A bioadhesive and/or water resistant adhesive protein may be used. Examples of an adhesive protein include, for example, but not limited to, mussel foot protein 3 (Mfp3) and mussel foot protein 5 (Mfp5).

In another aspect, the package material composition includes a preservative. Any suitable preservative known to one of skilled in the art can be used. In one example, the preservative is a natural antioxidant. In another example, preservative is butylated hydroxyanisole (BHA), butylated hydroxytoluene (BHT), or a combination thereof.

Suitable additives or fillers, known to one of skilled in the art, can also be in the package material composition.

In a particular embodiment, the package material composition is coated with a wax layer. Any suitable wax, known to one of skilled in the art, can be used.

The package material composition of the invention may provide a structural integrity or mechanical stability as well as one or more barrier properties in order to serve a full range of uses for packing and shipping of various products, for example, wet and dry products. In one example, the composition of the invention provides a moisture barrier property (e.g., an improved water vapor permeability). In another example, the composition of the invention provides an oxygen barrier property or air-tightness property. In some embodiments, the composition of the invention provides an improved elongation, an improved tensile strength, or a combination thereof.

In one aspect, the package material composition of the invention provides a property (e.g., structural integrity) for molding into a package for a dry or solid product. Examples a package for a dry or solid product include, for example, but not limited to, a food package, a bag, a box, a tray, an egg carton, a film, and a wrapper.

In another aspect, the package material composition of the invention provides a property (e.g., structural integrity) for molding into a package for a wet or liquid product. Examples a package for a wet or liquid product include, for example, but not limited to, a beverage pack, a milk carton, a can, a tetra pack, a bowl, and a bottle.

The composition of the invention is not limited to a food package. In some embodiments, the composition of the invention can be used for making a non-food package or non-package articles, for example, but not limited to, a plate, a spoon, a napkin, a straw, a stir stick, a padding material for shipping, or a cosmetic pack.

In another aspect the composition of the invention comprises a plurality of first layers and one or more second layers, wherein the second layer is present between two first layers, wherein the second layer has a plurality of openings that facilitate said two first layers to bond with each other, wherein the first layer comprises said protein component (e.g., corn zein) and the second layer comprises said polysaccharide (e.g., carrageenan).

The invention also provides a method for making a package, the method comprising: providing an edible and biodegradable package material composition, heating said composition, molding said composition into said package.

In a further aspect, the invention provides a method for making a package, said method comprising: providing a first composition and second composition, wherein said first composition comprises a protein component and said second composition comprises a polysaccharide; heating said first and second compositions; molding said first composition in to a first layer and said composition in to a second layer; and placing said second layer between two first layers. The layers can then be used for molding into a package.

Methods for making a making a package from a package material composition (e.g., films or sheets) are well known in the art. Any suitable method, known to one of skilled in the art, can be used. Sheets or films of the Invention can be rolled out in various thicknesses by industrial machinery and used commercially for bagging, wrapping or packaging products.

Sheets or films of the Invention can be extruded into molds forming bottles and containers of various size and shape.

The package material composition of the invention, described herein, can be used for any suitable packaging type. Examples of a packaging type include, for example, but not limited to, a vacuum packaging, a modified atmospheric packaging, a controlled atmospheric packaging, an active packaging, and an antimicrobial packaging.

In one aspect, the Invention is an edible substitute for conventional plastic or paper package. The package or product made of the composition of the invention is digestible because of the natural organic ingredients and the process by which it is made. The human digestive system has enzymes to do proteolysis (break down) these ingredients and digest them. In another aspect, the Invention is a biodegradable substitute for conventional plastic or paper packaging. Microbes in the environment have the capability of secreting enzymes for proteolysis and glycolysis of the package of the invention.

As used herein, the singular form “a,” “an” and “the” include plural references unless the context clearly dictates otherwise. For example, the term “a component” may include a plurality of components, including mixtures thereof.

Various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub ranges as well as individual numerical values within that range. For example, description of a range such as from 1 to 6 should be considered to have specifically disclosed sub ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranges between” a first indicate number and a second indicate number and “ranges from” a first indicate number “to” a second indicate number are used herein interchangeably and are meant to include the first and second indicated numbers and all the fractional and integral numerals there between.

As used herein, the term “method” refers to manners, means, techniques and procedures for accomplishing a given task including, but not limited to, those manners, means, techniques and procedures either known to, or readily developed from known manners, means, techniques and procedures by practitioners of the arts.

Any patent, patent application publication, or scientific publication, cited herein, is incorporated by reference herein in its entirety.

In the following examples, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Thus these examples should in no way be construed, as limiting the broad scope of the invention.

### EXAMPLES

### Example 1

### Component List of a Package Material

1. Wheat Gluten.
2. Carrageenan.
3. Ethanol.
4. Glycerin.
5. Distilled Water.
6. Sodium Hydroxide.
7. Corn Zein.
8. Cellulose.
9. Arabica.
10. Soy Protein.
11. Gelatin
13. Flavors—Pomegranate, Mango, Coconut, Tangerine, Orange, Passion fruit.
14. Colors—Red, Pink, Fuchsia, Green, Blue, Orange, Violet.

### Example 2

### Process for Preparing a Film Having Wheat Gluten and Carrageenan

(a) Dissolve 5.5 g gluten (#1), in 36 mL of 95% ethanol (#3) and add 2.5 mL glycerin (#4) to it. Glycerin is used as a plasticizer in order to minimize the crack and brittleness in the film.

(b) Warm and stir the solution continuously using a magnetic stirrer/hot plate. Adjust pH to 12 using sodium hydroxide (#6).

(c) Dissolve 2 g of carrageenan (#2) in 24 mL of distilled water (#5). Add the pH adjusted wheat gluten (#1) solution to it.

(d) Heat the mixture on a hot plate at 50 C until gluten (#1) and carrageenan (#2) is dispersed and the viscosity of solution decreases. Now the film-forming solution is ready to cast.

(e) Add 1 drop of color and flavor.

(f) Now the film-forming solution is ready to cast.

(g) When the film-forming solution is warm, cast on a clean flat glass surface, spread evenly on the glass surface and dry in an air-circulating oven set at 45° C. for 5 hr. At the end of the drying period, peel off the films from the glass surface.

### Example 3

### Process for Preparing a Film Having Wheat Gluten and Corn Zein

(a) Dissolve 3.5 g gluten (#1), 3.5 gZein (#7) in 36 mL of 95% ethanol (#3) and add 2.5 mL glycerin (#4) to it. Glycerin is used as a plasticizer in order to minimize the brittleness in the film.

(b) Warm and stir the solution continuously using a magnetic stirrer/hot plate. Add slowly 24 mL of distilled water (#5) and adjust pH to 12 using sodium hydroxide (#6).

(c) Heat the mixture on a hot plate at 50° C. until gluten (#1) and zein (#7) is dispersed and the viscosity of solution decreases.

(d) Add 1 drop of color and flavor.

(e) Now the film-forming solution is ready to cast.

(f) When the film-forming solution is warm, cast on a clean flat glass surface. Spread evenly on the glass surface and dry in an air-circulating oven set at 45° C. for 6 hr. At the end of the drying period, peel off the films from the glass surface.

### Example 4

### Process for Preparing a Film Having Cellulose and Carrageenan

(a) Dissolve 2 g Cellulose (#8) and 2 g Carrageenan (#2) in 50 mL of distilled water (#5) add 2 mL glycerin (#4) to it. Glycerin is used as a plasticizer in order to minimize the brittleness in the film.

(b) Heat the mixture on a hot plate at 65 C until mixture is dispersed and clear. Now the film-forming solution is ready to cast.

(c) When the film-forming solution is warm, cast on a clean glass surface. Spread evenly on the glass surface and dry in an air-circulating oven set at 60° C. for 4 hr. At the end of the drying period, peel off the films from the glass surface.

### Example 5

### Process for Preparing a Film Having Wheat Gluten

(a) Dissolve 7.5 g gluten (#1) in 36 mL of 95% ethanol (#3) and add 2.5 mL glycerin (#4) to it. Glycerin is used as a plasticizer in order to minimize the brittleness in the film.

(b) Warm and stir the solution continuously using a magnetic stirrer/hot plate. Add slowly 24 mL of distilled water and adjust pH to 12 using sodium hydroxide.

(c) Heat the mixture on a hot plate until gluten is dispersed and the viscosity of solution decreases. Now the film-forming solution is ready to cast.

(d) When the film-forming solution is warm, cast on a clean flat glass surface. Spread evenly on the glass surface and dry in an air-circulating oven set at 37° C. overnight. At the end of the drying period, peel off the films from the glass surface.

### Example 6

### Process for Preparing a Package Material Having Soy Protein Isolate, Carrageenan, Coffee (Arabica), and Sugar

(a) Brew coffee arabica (#9). Measure the volume.

(b) Dissolve 7.5 g Soy protein (#10) isolate, 4 g Carrageenan (#2) in 50 mL of distilled water (#5) and add 2.5 mL glycerin (#4) to it. Glycerin is used as a plasticizer in order to minimize the crack and brittleness in the film.

(c) Mix the coffee solution to the mixture and total volume should be 100 mL.

(d) Stir well and heat the mixture on a hot plate at 65° C. until soy protein and carrageenan is dispersed and solution becomes solidified. Now the film-forming solution is ready to cast.

(e) When the film-forming solution is warm, cast on a clean flat glass surface. Spread evenly on the glass surface and dry in an air-circulating oven set at 70° C. for 2 hr and 25° C. overnight. At the end of the drying period, peel off the films from the glass surface.

### Example 7

### Process for Preparing a Film Having Corn Zein and Gelatin

(a) Dissolve 1 g of Gelatin (#11) in 10 mL of distilled water (#5). Mix well until the solution is homogeneous.

(b) Add 10 mL of solution prepared for Zein film [Heated mixture]

(c) If it is insoluble add 15-20 mL of ethanol (#3) to it. Heat it up until they are dissolved.

(d) Add 1 drop of color and flavor.

(e) Pour the solution to a casting surface (Petridishes) and spread evenly.

(f) The solution was dried at room temperature. Film dried within 1 hour and could be peeled off from the surface.

### Example 8

### Process for Preparing a Film Having Corn Zein and Carrageenan

(a) Dissolve 5.5 gZein (#7) in 36 mL of 95% ethanol (#3) and add 2.5 mL glycerin (#4) to it. Glycerin is used as a plasticizer in order to minimize the crack and brittleness in the film.

(b) Stir the solution continuously using a magnetic stirrer/hot plate.

(c) Dissolve 2 g of carrageenan (#2) in 24 mL of distilled water. Add the Zein solution (#7) to it.

(d) Heat the mixture on a hot plate at 50 C until carrageenan and zein is dispersed.

(e) Add 1 drop of color and flavor.

(f) Now the film-forming solution is ready to cast.

(g) When the film-forming solution is warm, cast on a clean flat glass surface. Spread evenly on the glass surface and dry in an air-circulating oven set at 70° C. for 4 hr. At the end of the drying period, peel off the films from the glass surface.

### Example 9

### Preparation of Carrageenan Films

(a) The solution of K-CRG was prepared separately by adding 0.5 g and 1 g K-CRG biopolymer in 50 mL distilled water.

(b) Then, the temperature of the solution was raised up to 65° C. and maintained for 10 min under agitation (1500 rpm) to get a better and uniformly mixed solution.

(c) 10% of CRG mass (0.05 g) of Glycerol was added to it.

(d) The solution was then cooled down to 45° C. under continuous agitation.

(e) The obtained solutions were cast on the petriplates.

(f) The trays were kept in a hot air circulating oven for drying at 45° C. for 4 h.

### Example 10

### Preparation of Carrageenan Films

(a) Dissolve 9 g of Carageenan and 3 mL of Glycerol in 300 mL of water. Stir well until all gelatin dissolve completely.

(b) Heat the solution at 70° C. and stir using a magnetic stirrer for until all blend well.

(c) Add one drop of yellow color and pomegranate flavor. Mix well

(d) Pour the solution to a casting surface and spread evenly. Leave it for drying at 60 C overnight.

### Example 11

### Preparation of Gelatin Film

(a) Dissolve 1.5 g of Gelatin in 25 mL of water). Stir well for 1 hour until all gelatin dissolve completely.

(b) Heat the solution at 70 C and stir using a magnetic stirrer for until all blend well.

(c) Pour the solution to a casting surface (disposable petriplates) and spread evenly.

(d) Leave it for drying at room temperature.

(e) Films could be peeled off but need to dry little bit more.

### Example 12

### Preparation of Gelatin Film

(a) Dissolve 5 g of Gelatin and 2 mL of Glycerol in 50 mL of water. Stir well until all gelatin dissolve completely.

(b) Heat the solution at 70 C and stir using a magnetic stirrer for until all blend well.

(c) Add one drop of Pink color and pomegranate flavor. Mix well

(d) Pour the solution to a casting surface and spread evenly. Leave it for drying at room temperature overnight.

### Example 13

### Preparation of Pure Chitosan Film

Materials: 2 g Microcrystal chitosan powder; 2 ml Acetic acid (CH3-COOH); and 100 ml Distilled water

(a) Put chitosan powder and distilled water in a 250 ml decanter glass and mix, until the solution is homogeneous.

(b) Add acetic acid and continue mixing until the liquid is homogeneous and clear, which takes around 0.5-1 hour.

(c) Pour to the glass plates and allow to dry for 24 hrs at 30 C

### Example 14

### Preparation of a Film or Straw Having Corn Zein, Whey, and Xanthum Gum (with Vitamins and Minerals)

(a) Dissolve 9 g of corn zein, 3 g of whey protein and 3 g of xanthum gum in 93 mL of 95% ethanol.

(b) Add 6 mL glycerin to it. Glycerin is used as a plasticizer in order to minimize the crack and brittleness in the film.

(c) Grind one tablet vitamin B12, Mineral and add a pinch of it along with 1 tsp Vitamin C and one drop of Vitamin D to the solution.

(d) Add one drop of fuchsia, sky blue color, or pink color and 3 drops of pomegranate flavor.

(e) Stir the solution continuously using a magnetic stirrer/hot plate.

(f) Heat the mixture on a hot plate at 50 C until all corn zein is dispersed. It takes approximately 5-10 min.

(g) When the film-forming solution is warm, cast on a clean flat surface. Spread evenly on the glass surface and dry in an air-circulating oven set at 60° C. for 4 h. At the end of the drying period, peel off the films from the glass surface.

(h) Cut the straw about 2 inch length. Fill with 0.5 mL of Edible adhesive.

(i) Seal both the ends. Leave at room temperature

### Example 15

### Preparation of Probiotic Edible Film

### Probiotics:

### Materials Required:

Lactobacillus strain—Lactobacillus rhamnosus and Lactobacillus caseii

MRS broth

MRS agar

Phosphate buffer saline (PBS)

### Preparation of Glystock:

(a) Frozen culture of Lactobacillus rhamnosus and Lactobacillus caseii were streaked on to a MRS agar plate and incubated at 37 C overnight

(b) Pick a colony of L. caseei and L. rhamnosus and inoculate in 5 mL of MRS broth.

(c) Incubate at 37 C for 7 h under anaerobic conditions.

(d) After 7 h mix 1 mL of culture and 1 mL of 50% Glycerol in a cryo tube and freeze at −80 C.

Preparation of probiotic edible film:

(a) One milliliter of sterile phosphate buffer saline pH 7.0 was added to the small frozen culture of L. rhamnosus and L. Casei.

(b) After adequate mixing the bacterial aliquot was transferred and streaked on set MRS-agar medium.

(c) The petri dishes were left to grow under anaerobic conditions in sealed plastic containers at 37 C for 48 h.

(d) A small amount of the colonies were collected with a sterilized loop and suspended 30 mL of MRS broth and incubated for 48 h at 37 C under anaerobic conditions.

(e) The final broth was transferred under aseptic conditions into 50 mL sterile centrifuge tubes and centrifuged at 3000 g for 5 min.

(f) After centrifugation, the supernatant was discarded and the harvested cells in the form of pellets were washed twice using phosphate buffer saline pH 7.0.

(g) The pellets were stored at −80 C.

(h) Take a small amount of pellet with the tip and dissolve in 500 uL of PBS.

(i) Cut small squares of corn, Gelatin and carrageenan film.

(j) Put them into small petridishes. Put 20 uL of PBS with L. rhamnsosus and L. Caseii onto the films in petridish.

(k) Allow them to dry out and keep undisturbed.

Estimation of survival of Lactobacillus in the film:

(a) Take each square (2 days, 2 weeks, 1 month after applying bacteria to film) of corn, Gelatin and carrageenan film containing L. rhamnosus and L. caseii and dissolve in 1 mL of sterile phosphate buffer saline pH 7.0.

(b) After adequate mixing do serial dilution. 1:2, 1:10. 1:100, 1:1000.

(c) Plate each of them and non diluted sample to MRS agar plates.

(d) Incubate at 37 C for 48 hours under anaerobic conditions.

TABLE 1
L. rahmnosus survival: Number of colonies
in the Plates after 2 days of plating

| No | Type | 1:2 | 1:10 | 1:100 | 1:1000 |
|---|---|---|---|---|---|
| 1 | Corn + whey | — | — | — | — |
| 2 | Gelatin | 88 | 45 | 70 | — |
| 3 | Carageenan | — | 350 | 3 | — |

TABLE 2
L. caseii survival: Number of colonies
in the Plates after 2 days of plating

| No | Type | 1:2 | 1:10 | 1:100 | 1:1000 |
|---|---|---|---|---|---|
| 1 | Corn + whey | — | — | — | — |
| 2 | Gelatin | Too many | 100 | 32 | — |
| 3 | Carageenan | Too many | 110 | −80 | — |

### Survival Rate for Corn Film:

Since corn film does not dissolve in PBS and we couldn't observe colonies even after a week, we placed the whole squares on the plates and incubate at 37 C for 48 h. After 48 h, we could observe colonies of Lactobacillus on the plates. The bacteria could survive for a month when applied to Corn, Gelatin and Carrageenan.

### Example 16

### Preparation of Multilayer Films

The corn zein film heat seals very well. After about one minute after exposing to water, the material sprung a leak mid-material (not at a weld joint).

When wet, the corn zein film starts to dissolve—the surface gets very “gooey” and slippery. After laying in water for a while, the component dissolves in water and when dried the remaining material is a stiff, lighter pink color.

The corn zein film thermoforms very nicely. The material would be compatible with general thermoforming and vacuum forming techniques and hold its form. However, the layers are not homogenous and as a result, the material has weak points that tear during stretching.

The gelatin film heat seals nicely. It can even hold liquid for a short period (longer than corn zein at present). It cannot be thermoformed, and shrinks somewhat under heat.

The carrageenan film cannot be heat sealed or thermoformed, but maintains its strength fairly well during these processes. It can likely be cast or dip-coated into any form you like, but it would have to be done at the initial stages rather than reformed from a sheet. It also becomes very loose & fragile when exposed to liquid, but not as weak as gelatin.

We have surprisingly and unexpectedly found a solution for the above discussed problems by having a multilayer packaging. Specifically, an intermediate layer having carrageenan with outer layers having corn zein exhibited unexpected properties of strength and ability to hold liquid.

An intermediate layer having carrageenan can have openings (e.g., circular openings or striped openings) so that two layers having corn zein can bond together through the openings.

FIG. 27A shows 3-layer thermal bonding with increased strength. Corn zein bonds to its self with carrageenan as intermediate layer. FIG. 27B shows 5-layer thermal bonding. Corn zein bonds to its self with carrageenan as intermediate layer. Carrageenan layers are offset to further increase the strength.

It will be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

What is claimed is:

1. A package material composition, said composition comprising:
a polysaccharide component, a protein component, or a combination thereof,
wherein said polysaccharide component is a carrageenan and said protein component is a zein, a gluten, a soy protein, a whey protein, or a combination thereof

2. The composition of claim 1, wherein said composition is biodegradable.

3. The composition of claim 1, wherein said composition is edible.

4. The composition of claim 1, further comprising a thickening agent.

5. The composition of claim 4, wherein said thickening agent is a gelling agent.

6. The composition of claim 5, wherein said gelling agent is a gelatin.

7. The composition of claim 1, further comprising a plasticizing agent.

8. The composition of claim 7, wherein said plasticizing agent is glycerol.

9. The composition of claim 1, further comprising a solvent.

10. The composition of claim 1, further comprising a starch or a sugar.

11. The composition of claim 1, further comprising a sweetner.

12. The composition of claim 1, further comprising a flavoring agent.

13. The composition of claim 1, further comprising a coloring agent.

14. The composition of claim 1, further comprising a preservative.

15. The composition of claim 1, further comprising a gum.

16. The composition of claim 1, further comprising an oil.

17. The composition of claim 1, further comprising a wax layer.

18. The composition of claim 1, further comprising an antimicrobial agent.

19. The composition of claim 1, further comprising one or more additional polysaccharide components.

20. The composition of claim 1, further comprising one or more additional protein components.

21. The composition of claim 1, further comprising one or more fiber components.

22. The composition of claim 1, further comprising an adhesive protein.

23. The composition of claim 1, wherein said composition provides a structural integrity for molding into a package for a dry or solid product.

24. The composition of claim 1, wherein said composition provides a structural integrity for molding into a package for a wet or liquid product.

25. The composition of claim 1, wherein said composition provides a structural integrity for molding into a food or a beverage package.

26. The composition of claim 1, comprising
a plurality of first layers and one or more second layers,
wherein the second layer is present between two first layers,
wherein the second layer has a plurality of openings that facilitate said two first layers to bond with each other,
wherein the first layer comprises said protein component and the second layer comprises said polysaccharide.

27. A package molded by a composition of claim 1.

28. A method for making a package, said method comprising:
providing a composition of claim 1,
heating said composition,
molding said composition in to said package.

29. A method for making a package, said method comprising:
providing a first composition and second composition, wherein said first composition comprises a protein component and said second composition comprises a polysaccharide
heating said first and second compositions,
molding said first composition in to a first layer and said composition in to a second layer;
placing said second layer between two first layers.

30. The method of claim 28, wherein the polysaccharide is a carrageenan and said protein component is a zein, a gluten, a soy protein, a whey protein, or a combination thereof

31. An edible and biodegradable package material composition, said composition comprising a plurality of first layers and one or more second layers, wherein the second layer is present between two first layers, wherein the second layer has a plurality of openings that facilitate said two first layers to bond with each other, wherein the first layer comprises an ingredient for providing a mechanical strength and the second layer comprises an ingredient for providing a moisture resistance.

32. An edible and biodegradable package material composition, said composition comprising a plurality of first layers and one or more second layers, wherein the second layer is present between two first layers, wherein the second layer has a plurality of openings that facilitate said two first layers to bond with each other, wherein the first layer comprises a zein protein and the second layer comprises a carrageenan.
